(19) United States
(12) Patent Application Publication
(10) Pub. No.: US 2017/0040838 A1
(43) Pub. Date: Feb. 9, 2017

(54) POWER MANAGEMENT APPARATUS WITH REMOTE MONITORING AND STANDBY POWER MECHANISM

(71) Applicant: Digipower Manufacturing Inc., New Taipei City (TW)

(72) Inventor: Min-Huang Huang, New Taipei City (TW)

(21) Appl. No.: 14/945,429

(22) Filed: Nov. 19, 2015

(30) Foreign Application Priority Data
Aug. 7, 2015 (TW) 104212752

(51) Int. Cl. H02J 9/06; H02M 7/04

(52) U.S. Cl. CPC H02J 9/061; H02M 7/04

(57) ABSTRACT

A power management apparatus including a peripheral control circuit, an input switching circuit and an output control circuit is provided. The peripheral control circuit communicates with a remote device and provides a control signal and switching signals accordingly. The input switching circuit detects AC powers, and selects one of the AC powers as a supply power according to the control signal. When the selected AC power fails, the input switching circuit selects the other AC power as the supply power within a predetermined time duration. The output control circuit receives the supply power and is controlled by the switching signal to provide output powers to external loads. The output control circuit detects power utilizing information of the external loads. The remote device obtains power statuses of the AC powers and the power utilizing information of the external loads via the peripheral control circuit to monitor the power management apparatus.

### CROSS-REFERENCE TO RELATED APPLICATION

This application claims the priority benefit of Taiwan application serial no. 104212752, filed on Aug. 7, 2015. The entirety of the above-mentioned patent application is hereby incorporated by reference herein and made a part of this specification.

### TECHNICAL FIELD

The disclosure relates to a power management apparatus, in particular, to a power management apparatus with a remote monitoring and standby power mechanism.

### BACKGROUND

In present, with an increasing number of appliances requiring powers, the quality and the safety of power usage have been highly demanded by people. For example, if a power source that supplies a server in a conventional data center is abnormal (e.g., power failure or unstable voltage), the server would not be able to operate, and the service would be disrupted. Moreover, when a large number of appliances are operating concurrently, it may cause danger due to overloaded power usage. Hence, to effectively monitor the amount of power usage and to ensure the reliability and the safety during power usage of appliances is a notable issue.

### SUMMARY

Accordingly, a power management apparatus with a remote monitoring and standby power mechanism is provided in the disclosure. Such power management apparatus includes a standby power feature. When the power source of the power management apparatus is abnormal, it may automatically switch the standby power source to allow a continuity of the power output by the power management apparatus. Moreover, the power management apparatus may be controlled by the remote apparatus so as to select a power source of the power management apparatus and may transmit a power utilizing information of the load of the power management apparatus and information of the environment in which the power management apparatus operates to the remote apparatus. Thus, the remote apparatus may remotely monitor the power management apparatus so as to enhance the reliability and the safety during the usage of appliances.

The power management apparatus provided in the disclosure includes a peripheral control circuit, an input switching circuit, and an output control circuit. The peripheral control circuit is connected to a control bus and configured to receive an input signal from a remote apparatus and accordingly provide a control signal or multiple switching signals to the control bus. The input switching circuit is connected to multiple external power systems to receive multiple alternating-current (AC) powers, and also connected to the control bus to receive the control signal. The input switching circuit selects one of the AC powers to be a supply power according to the control signal and detects a power status of each of the AC powers. When the power status of the selected AC power indicates that the selected AC power fails, the input switching circuit selects another AC power from the AC powers to be the supply power within a predetermined time duration. The output control circuit is connected to the input switching circuit to receive the supply power, and also connected to the control bus to receive the switching signals. The output control circuit is controlled by the switching signals to provide multiple output powers to a plurality of external loads. The output control circuit detects a voltage and a current of the supply power to measure power utilizing information of the external loads. The peripheral control circuit transmits the power status of each of the AC powers and the power utilizing information of the external loads to the remote apparatus so as to allow the remote apparatus to remotely monitor the power management apparatus.

According to an embodiment of the disclosure, the output control circuit includes an electric energy measuring circuit and at least one sub-circuit. The electric energy measuring circuit is connected to the input switching circuit to receive the supply power, accordingly measure a total energy consumption of the external loads and provide at least one sub-power. The at least one sub-circuit is connected to the electric energy measuring circuit to receive the at least one sub-power, and also connected to the control bus to receive the switching signals. The at least one sub-circuit detects a current value of the at least one sub-power and is controlled by the switching signals to provide the output powers.

According to an embodiment of the disclosure, the electric energy measuring circuit is connected to the control bus and compares the total energy consumption with a contract capacity. When the total energy consumption is greater than or equal to the contract capacity, the electric energy measuring circuit outputs the switching signals to disable at least one sub-circuits.

According to an embodiment of the disclosure, the electric energy measuring circuit is connected to the control bus. The peripheral control circuit transmits the total energy consumption to the remote apparatus. The remote apparatus compares the total energy consumption with a contract capacity. When the total energy consumption is greater than or equal to the contract capacity, the remote apparatus outputs the switching signals via the peripheral control circuit to disable the at least one sub-circuit.

According to an embodiment of the disclosure, the at least one sub-circuit includes a circuit breaker, a current measuring circuit, and multiple output switching circuits. The circuit breaker is connected to the electric energy measuring circuit to receive and transmit the at least one sub-power, and also perform over-current protection on the at least one sub-circuit. The current measuring circuit is connected to the circuit breaker to receive and transmit the at least one sub-power, and is configured to measure the current value of the at least one sub-power. The output switching circuits are connected to the current measuring circuit to receive the at least one sub-power. Each of the output switching circuits is controlled by the corresponding switching signal to provide the corresponding output power to the corresponding external load.

According to an embodiment of the disclosure, the current measuring circuit compares the current value of the at least one sub-power with a threshold. When the current value of the at least one sub-power is greater than or equal to the threshold, the current measuring circuit outputs the switching signals to turn off the output switching circuits.

According to an embodiment of the disclosure, the peripheral control circuit transmits the current value of the at least one sub-power to the remote apparatus. The remote apparatus compares the current value of the at least one sub-power with a threshold. When the current value of the at least one sub-power is greater than or equal to the threshold, the remote apparatus outputs the switching signals via the peripheral control circuit to turn off the output switching circuits.

According to an embodiment of the disclosure, the peripheral control circuit includes a communication module and a controller. The communication module is configured to receive the input signal from the remote apparatus. The controller is connected to the communication module. The controller receives the input signal via the communication module, provides the control signal or the switching signals accordingly, and transmits the power status of each of the AC powers and the power utilizing information of the external loads to the remote apparatus via the communication module so as to allow the remote apparatus to remotely monitor the power management apparatus.

According to an embodiment of the disclosure, the peripheral control circuit further includes at least one sensor port. The at least one sensor port is connected to the controller and configured to be plugged into at least one external sensor to detect at least one environment parameter of an environment in which the power management apparatus operates. The controller transmits the at least one environment parameter to the remote apparatus via the communication module so as to allow the remote apparatus to remotely monitor the power management apparatus according to the at least one environment parameter.

According to an embodiment of the disclosure, the peripheral control circuit further includes a storage module. The storage module is connected to the controller and configured to store the at least one environment parameter.

According to an embodiment of the disclosure, the peripheral control circuit further includes at least one digital input/output (I/O) port. The at least one digital I/O port is connected to the controller and configured to be plugged into the at least one external digital sensor or at least one external digital controller to detect or control at least one environment status of an environment in which the power management apparatus operates. The controller transmits the at least one environment status to the remote apparatus via the communication module so as to allow the remote apparatus to remotely monitor the power management apparatus according to the at least one environment status.

According to an embodiment of the disclosure, the peripheral control circuit further includes a display module. The display module is connected to the controller and configured to display operation statuses of the power management apparatus. The controller is further configured to detect an Internet protocol (IP) address of the power management apparatus. In response to a press operation of a key module, the controller sequentially displays the IP address and the operation statuses of the power management apparatus on the display module.

According to an embodiment of the disclosure, the power management apparatus further includes multiple alternating current to direct current (AC-DC) converting circuits. The AC-DC converting circuits respectively connected to the external power systems to receive the AC powers. An output terminal of each of the AC-DC converting circuits is connected to each other, and each of the AC-DC converting circuits performs AC-DC conversion on the corresponding AC power to generate a DC power required to operate the power management apparatus.

In summary, the power management apparatus in the disclosure provides a standby power feature. When the power source of the power management apparatus is abnormal, it may automatically switch the standby power source to allow a continuity of the power output by the power management apparatus. Moreover, the power management apparatus may be controlled by the remote apparatus so as to select a power source of the power management apparatus and may transmit a power utilizing information of the load (e.g., an appliance) of the power management apparatus and information of the environment in which the power management apparatus operates (e.g., a temperature value, a humility value, or a pressure value) to the remote apparatus via a wired network or a wireless network. Accordingly, the remote apparatus may remotely monitor the power management apparatus so as to enhance the reliability and the safety during the usage of appliances.

To make the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a schematic diagram of an application of a power management apparatus with a remote monitoring and standby power mechanism.

FIG. 1B illustrates a block diagram of the power management apparatus as illustrated in FIG. 1A.

FIG. 1C is a block schematic diagram of the peripheral control circuit of the power management apparatus illustrated in FIG. 1A and FIG. 1B.

FIG. 2 illustrates a decomposition diagram of the power management apparatus in FIG. 1.

FIG. 3 is a configuration diagram of a back cover of the power management apparatus illustrated in FIG. 2.

FIG. 4 is a configuration diagram of a front cover of the power management apparatus illustrated in FIG. 2.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

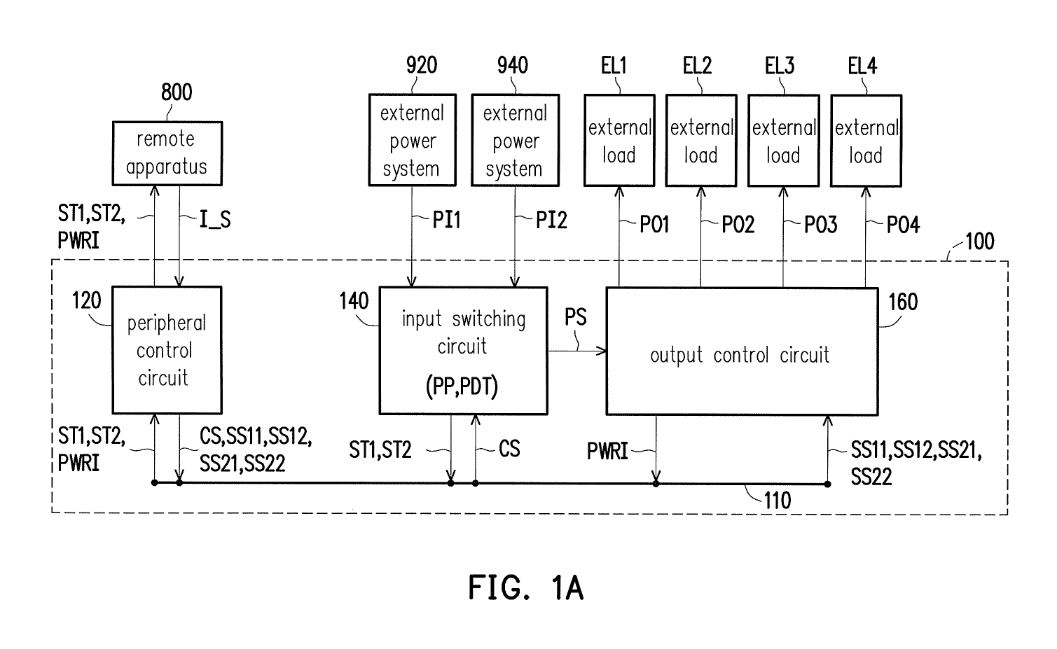

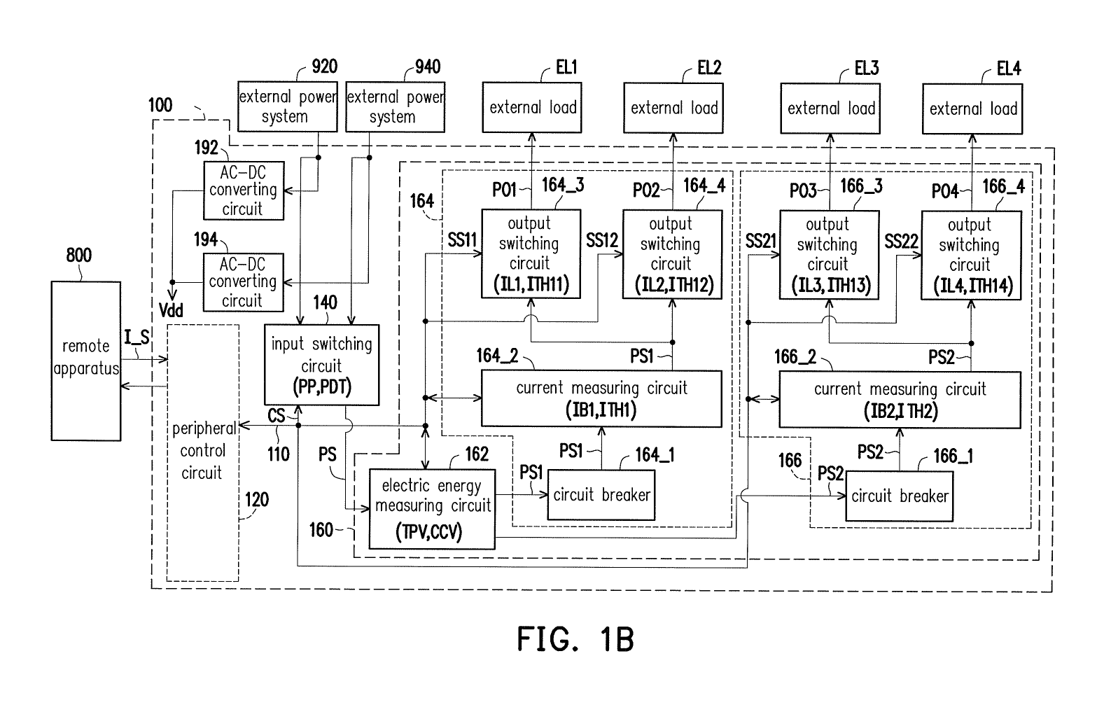

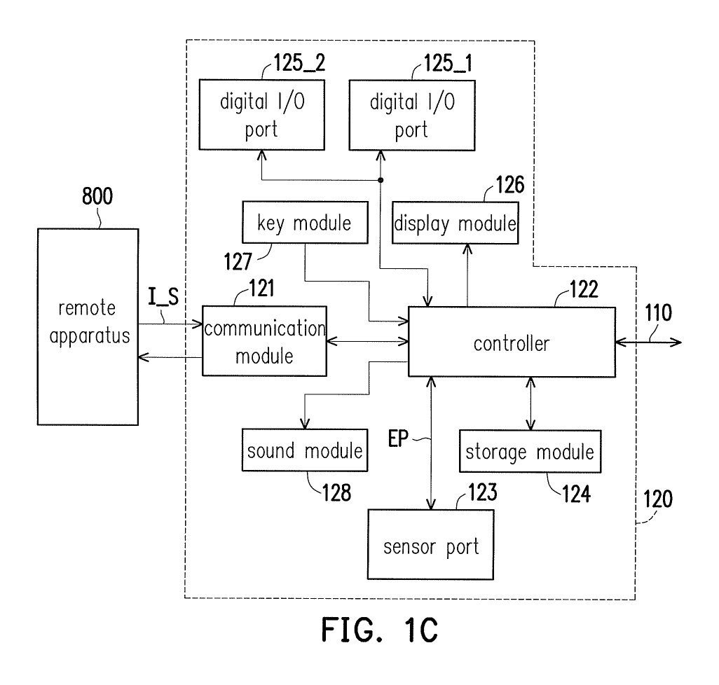

FIG. 1A illustrates a schematic diagram of an application of a power management apparatus 100 with a remote monitoring and standby power mechanism, and FIG. 1B illustrates a block diagram of the power management apparatus 100 as illustrated in FIG. 1A. The power management apparatus 100 may include a peripheral control circuit 120, an input switching circuit 140, and an output control circuit 160. The peripheral control circuit 120 is connected to a control bus 110 and may be configured to receive an input signal I_S from a remote apparatus 800 and accordingly provide a control signal CS or multiple switching signals SS11, SS12, SS21, and SS22 to the control bus 110.

The input switching circuit 140 is connected to multiple external power systems 920 and 940 so as to receive multiple alternating-current (AC) powers PI1 and PI2. The input switching circuit 140 is also connected to the control bus 110 so as to receive the control signal CS. The input switching circuit 140 may select one of the AC powers PI1 and PI2 (e.g., the AC power PI1) as a supply power PS according to a predetermined parameter PP or the control signal CS. The input switching circuit 140 may detect power statuses ST1 and ST2 of the AC powers PI1 and PI2 respectively. When the power status ST1 of the AC power PI1 indicates that the AC power PI1 fails, the input switching circuit 140 may select the AC power PI2 as the supply power PS within a predetermined time duration PDT (such as, but not limited to, 8 ms).

To be specific, the external power systems 920 and 940 may be two independent power systems to respectively provide the two independent AC powers PI1 and PI2. The input switching circuit 140 may detect the power status ST1 of the AC power PI1 and the power status ST2 of the AC power PI2 at any time. If the detected power statuses ST1 and ST2 indicate that the AC power PI2 and PI2 are both active, the input switching circuit 140 may select one of the AC powers PI1 and PI2 as the supply power PS of the power management apparatus 100 according to the predetermined parameter PP. Assume that the input switching circuit 140 selects the AC power PI1 as the supply power PS of the power management apparatus 100 according to the predetermined parameter PP. Once the input switching circuit 140 detects that an output voltage of the AC power PI1 from the external power system 920 is unstable or zero, it may switch a power source of the supply power PS to the external power system 940 within a predetermined time duration PDT (e.g., within a clock period of the input switching circuit 140). Meanwhile, the input switching circuit 140 may set the AC power PI2 as the supply power PS of the power management apparatus 100. Hence, it would prevent the power management apparatus 100 from a discontinuity of the output power due to power failure.

Additionally, the peripheral control circuit 120 may transmit the power statuses ST1 and ST2 of the AC powers PI1 and PI2 detected by the input switching circuit 140 (such as, but not limited to, voltage values) to the remote apparatus 800. Hence, the remote apparatus 800 may monitor the power statuses ST1 and ST2 of the AC powers PI1 and PI2 at any time, determine whether to transmit the input signal IS according to the power statuses ST1 and ST2 of the AC powers PI1 and PI2 so as to notify the peripheral control circuit 120 to generate the control signal CS, and accordingly control the input switching circuit 140 to switch the power source of the supply power PS.

For example, if the power statuses ST1 and ST2 received by the remote apparatus 800 indicate that the AC powers PI1 and PI2 are both active, the remote apparatus 800 may select the AC power PI1 to be the supply power PS of the power management apparatus 100, and yet the disclosure is not limited herein. Once the power status ST1 received by the remote apparatus 800 indicates that the output voltage of the AC power PI1 from the external power system 920 is unstable or zero, the remote apparatus 800 may transmit the input signal I_S so as to notify the peripheral control circuit 120 to generate the control signal CS and switch the power source of the supply power PS to the external power system 940, Meanwhile, the input switching circuit 140 may set the AC power PI2 as the supply power PS of the power management apparatus 100. Hence, it would prevent the power management apparatus 100 from a discontinuity of the output power due to power source failure.

In the aforesaid embodiments of the disclosure, the input switching circuit 140 may be implemented by a microprocessor, a digital signal processor (DSP), an application-specific integrated circuit (ASIC), or a field-programmable gate array (FPGA), and yet the disclosure is not limited herein.

It should be noted that, the power management apparatus 100 which is connected to the two external power system 920 and 940 to receive the two AC powers PI1 and PI2 as illustrated in FIG. 1A and FIG. 1B is merely served as an example and does not restrict the disclosure. The number of the AC powers that the power management apparatus 100 uses for standby power may be determined by the designer based on an actual application or a design requirement.

The output control circuit 160 is connected to the input switching circuit 140 to receive the supply power PS. The output control circuit 160 is also connected to the control bus 110 to receive switching signals SS11, SS12, SS21, and SS22. The output control circuit 160 is controlled by the switching signals SS11, SS12, SS21, and SS22 for outputting output powers PO1-PO4 to multiple external loads EL1-EL4 for power supply. The power management apparatus 100 connected to the four external loads EL1-EL4 as illustrated in FIG. 1A and FIG. 1B is merely served as an example and does not restrict the disclosure. The number of the external loads connected by the power management apparatus 100 may be determined by the designer based on an actual application or a design requirement.

The output control circuit 160 may be used for detecting a voltage and a current of the supply power PS so as to measure power utilizing information PWRI of the external loads EL1-EL4. For example, the output control circuit 160 may detect the voltage and the current of the supply power PS and measure a total current consumption, a total power consumption, or a total energy consumption, and yet the disclosure is not limited herein.

On the other hand, the peripheral control circuit 120 may transmit the power utilizing information PWRI of the external loads EL1-EL4 (such as, but not limited to, the total current consumption, the total power consumption, or the total energy consumption) to the remote apparatus 800 so as to allow the remote apparatus 800 to remotely monitor or warn the power management apparatus 100. Details would be provided later on.

As illustrated in FIG. 1B, the output control circuit 160 may include an electric energy measuring circuit 162 and at least one sub-circuit 164 and 166. The electric energy measuring circuit 162 is connected to the input switching circuit 140 to receive the supply power PS, measure the total energy consumption TPV of the external loads EL1-EL4, and supply at least one sub-power PS1 and PS2.

The sub-circuit 164 is connected to the electric energy measuring circuit 162 to receive the sub-power PS1 and connected to the control bus 110 to receive the switching signals SS11 and SS12. The sub-circuit 164 may detect the current of the sub-power PS1 and is controlled by the switching signals SS11 and SS12 to provide the output powers PO1 and PO2. Similarly, the sub-circuit 166 is connected to the electric energy measuring circuit 162 to receive the sub-power PS2 and connected to the control bus 110 to receive the switching signals SS21 and SS22. The sub-circuit 166 may detect the current of the sub-power PS2 and is controlled by the switching signals SS21 and S22 to provide the output powers PO3 and PO4.

In an embodiment of the disclosure, the electric energy measuring circuit 162 may be connected to the control bus 110. The electric energy measuring circuit 162 may compare the total consumption energy TPV of the measured external loads EL1-EL4 with a contract capacity CCV. When the total consumption energy TPV is greater than or equal to the contract capacity CCV, the electric energy measuring circuit 162 may generate and output the switching signals SS11, S12, SS21, and SS22 to disable the sub-circuits 164 and 166. In other words, the total consumption energy TPV of the external loads EL1-EL4 have reached an energy usage assigned by a power company (i.e., the contract capacity CCV), and thus the sub-circuits 164 and 166 would no longer provide power to the external loads EL1-EL4.

In another embodiment of the disclosure, the electric energy measuring circuit 162 may be connected to the control bus 110. The peripheral control circuit 120 may transmit the total consumption energy TPV of the external loads EL1-EL4 measured by the electric energy measuring circuit 162 to the remote device 800. The remote device 800 may compare the total consumption energy TPV with the contract capacity CCV. When the total consumption energy TPV is greater than or equal to the contract capacity CCV, the remote device 800 may transmit the output signal I_S to notify the peripheral control circuit 120 to generate and output the switching signals SS11, SS12, SS21, and SS22 to disable the sub-circuits 164 and 166. In other words, the total consumption energy TPV of the external loads EL1-EL4 have reached an energy usage assigned by a power company (i.e., the contract capacity CCV), and thus the remote device 800 would remotely control the sub-circuits 164 and 166 not to provide power to the external loads EL1-EL4.

In the aforesaid embodiments of the disclosure, the electric energy measuring circuit 162 may be implemented by a wattmeter, and yet the disclosure is not limited thereto.

It should be noted that, the power management apparatus 100 illustrated in FIG. 1A which provides the four output powers PO1-PO4 to the four external loads EL1-EL4 is merely illustrated as an example, and yet the disclosure is not limited herein. The number of the output powers provided by the power management apparatus in the disclosure may be determined by the designer based on an actual application or a design requirement. Besides, the two sub-circuits 164 and 166 are disposed in the output control circuit 160 as illustrated in FIG. 1B, where the sub-circuit 164 configured to provide power to the two external loads EL1 and EL2 and the sub-circuit 166 configured to provide energy to the external loads EL3 and EL4 are merely served as examples, and yet the disclosure is not limited thereto. For power management on the external loads, the designer may dispose at least one sub-circuit in the power management apparatus in the disclosure based on an actual application or a design requirement, where each of the sub-circuits may provide at least one output power to at least one external load.

Since the circuit architectures of the sub-circuits 164 and 166 illustrated in FIG. 1B are similar, only the implementation of the sub-circuit 164 would be illustrated. The implementation of the sub-circuit 166 may refer to the description of the sub-circuit 164.

The sub-circuit 164 may include a circuit breaker 164_1, a current measuring circuit 164_2, and output switching circuits 164_3-164_4. The circuit breaker 164_1 may be connected to the electric energy measuring circuit 162 to receive and transmit sub-power PS1 and perform over-current protection on the sub-circuit 164. In short, when a current passing the circuit breaker 164_1 is overloaded, the circuit breaker 164_1 may automatically trip so as to allow the sub-circuit 164 to be an open circuit for over-current protection. In an embodiment of the disclosure, the output switching circuits 164_3-164_4 may also be used for performing over-current protection on the sub-circuit 164. Hence, the circuit breaker 164_1 could be omitted to reduce the cost of the power management apparatus 100.

The current measuring circuit 164_2 may be connected to the circuit breaker 164_1 to receive and transmit the sub-power PS1. The current measuring circuit 164_2 may be configured to measure a current value IB1 of the sub-power PS1. The output switching circuits 164_3 and 164_4 are connected to the current measuring circuit 164_2 to receive the sub-power PS1. The output switching circuit 164_3 may be controlled by the corresponding switching signal SS11 to provide the corresponding output power PO1 to the corresponding external load ELL The output switching circuit 164_4 may be controlled by the corresponding switching signal SS12 to provide the corresponding output power PO2 to the corresponding external load EL2.

In an embodiment of the disclosure, the current measuring circuit 164_2 may compare the current value IB1 of the sub-power PS1 with a threshold ITH1. When the current value IB1 is greater than or equal to the threshold ITH1, the current measuring circuit 164_2 may output the switching signal SS11 and SS12 to turn off the output switching circuit 164_3 and 164_4 or turn off one of the output switching circuits 164_3 and 164_4 to reduce the current value IB1 of the sub-power PS1. Accordingly, besides the sub-circuit 164 is over-current protected, each of the output switching circuit 164_3 and 164_4 are controlled to adjust the current value IB1 of the sub-power PS1.

In another embodiment of the disclosure, the peripheral control circuit 120 may transmit the current value IB1 of the sub-power PS1 measured by the current measuring circuit 164_2 to the remote apparatus 800. The remote apparatus 800 may compare the current value IB1 of the sub-power PS1 with the threshold ITH1. When the current value IB1 of the sub-power PS1 is greater than or equal to the threshold ITH1, the remote apparatus 800 may notify the peripheral control circuit 120 to generate the switching signals SS11 and SS12 so as to turn off the output switching circuits 164_3 and 164_4 or turn off one of the switching circuits 164_3 and 164_4 to reduce the current value IB1 of the sub-power PS1. Accordingly, besides the sub-circuit 164 is over-current protected, each of the output switching circuit 164_3 and 164_4 are controlled to adjust the current value IB1 of the sub-power PS1.

In another embodiment of the disclosure, the output switching circuits 164_3 and 164_4 may be respectively configured to measure current values IL1 and IL2 of the output power PO1 and PO2. The output switching circuit 164_3 may compare the current value IL1 of the output power PO1 with a threshold ITH11. When the current value IL1 is greater than or equal to the threshold ITH11, the output switching circuit 164_3 may generate the switching signal SS11 to turn off the output switching circuit 164_3. The operation of the output switching circuit 164_4 may be deduced in the same fashion and would not be repeated herein. Accordingly, each of the switching circuits 164_3 and 164 _4 may be over-current protected individually.

In the aforesaid embodiments of the disclosure, the current measuring circuit 164_2 may be implemented by a microprocessor, a digital signal processor (DSP), an application-specific integrated circuit (ASIC), or a field-programmable gate array (FPGA). Each of the output switching circuits 164_3 and 164_4 may include a relay. However, the disclosure is not limited thereto.

The peripheral control circuit 120 would be illustrated as follows. FIG. 1C is a block schematic diagram of the peripheral control circuit 120 of the power management apparatus 100 illustrated in FIG. 1A and FIG. 1B. Referring to FIG. 1A, FIG. 1B, and FIG. 1C, the peripheral control circuit 120 may include a communication module 121 and a controller 122. The communication module 121 is configured to receive the input signal I_S from the remote apparatus 800. The controller 122 is connected to the communication module 122. The controller 122 may receive the input signal I_S via the communication module 121 and provide the control signal CS or the switching signals SS11, SS12, SS21, and S22 to the control bus 110 accordingly. The controller 122 may transmit the power statuses ST1 and ST2 of the AC powers PI1 and PI2 and the power utilizing information PWRI of the external loads EL1-EL4 to the remote apparatus 800 so as to allow the remote apparatus 800 to remotely monitor the power management apparatus 100. The power utilizing information PWRI of the external loads EL1-EL4 may include the total power consumption TPV of the external loads EL1-EL4, the current values IB1 and IB2 of the sub-powers PS1 and PS2, or on/off statuses of the output switching circuits 164_3, 164_4, 166_3, and 166_4, and yet the disclosure is not limited herein. The power statuses ST1 and ST2 of the AC powers PI1 and PI2 may include voltage values (or current values) of the AC powers P11 and PI2 or a power source of the supply power PS (i.e., from the AC power PI1 or PI2), and yet the disclosure is not limited herein.

In the aforesaid embodiments of the disclosure, the controller 122 may be implemented by a microprocessor, a digital signal processor (DSP), an application-specific integrated circuit (ASIC), or a field-programmable gate array (FPGA), and yet the disclosure is not limited thereto.

In an embodiment of the disclosure, the communication module 121 may be a wired communication module or a wireless communication module. If the communication module 121 is a wired communication module, it could be implemented by the Ethernet and connected to a network system via the Ethernet port (e.g., RJ45 port) to communicate with the remote apparatus 800, and yet the disclosure is not limited thereto. If the communication module 121 is a wireless communication module, it may communicate with the remote apparatus 800 via an external access point (AP). The wireless communication module may include a Wi-Fi module, a global system for mobile communication (GSM) module, a code division multiple access (CDMA) module, a wideband CDMA (WCDMA) module, a CDMA-2000 module, a worldwide interoperability for microwave access (WiMAX) module, a long term evolution (LTE) module, a wireless local area network (WLAN) module, or a ultra wideband (UWB) module, and so forth. The disclosure is not limited herein.

In an embodiment of the disclosure, the peripheral control circuit 120 may further include at least one sensor port 123. The sensor port 123 may be connected to the controller 122 and configured to plug into an external sensor (for example, but not limited to, a temperature sensor, a humidity sensor, or a pressure sensor) so as to detect at least one environment parameter EP of an environment in which the power management apparatus 100 operates. The environment parameter EP may at least include a temperature value, a humility value, or a pressure value of the environment in which the power management apparatus 100 operates, and yet the disclosure is not limited herein. The controller 122 may transmit the environment parameter EP to the remote apparatus 800 via the communication module 121 so as to allow the remote apparatus 800 to remotely monitor the power management apparatus 100 according to the environment parameter EP. For example, when the remote apparatus 800 identifies that the temperature of the environment in which the power management apparatus 100 operates is too high according to the environment parameter EP, the remote apparatus 800 may notify the peripheral control circuit 120 to provide the switching signals SS11, SS12, SS21, and SS22 to turn off a portion of the switching circuits 164_3, 164_4, 166_3, and 166_4 or turn on a cooling device (e.g., a fan) in the power management apparatus 100. This could prevent the power management apparatus 100 from dangers due to excess temperature.

In an embodiment of the disclosure, the peripheral control circuit 120 may further include a storage module 124. The storage module 124 is connected to the controller 122 and may be configured to storage the environment parameter EP, and yet the disclosure is not limited herein. The storage module 124 may be also configured to store the power statuses ST1 and S2 of the AC powers PI1 and PI2, or the power utilizing information PWRI of the external loads EL1-EL4. The storage module 124 may be implemented by a memory module composed by any type of memory such as a random access memory (RAM), a static random access memory (SRAM), a flash memory, and so forth. The disclosure is not limited thereto.

In an embodiment of the disclosure, the peripheral control circuit 120 may further include at least one digital I/O port 125_1 and 125_2. The digital I/O ports 125_1 and 125_2 may be connected to the controller 122 and configured to plug into at least one external digital sensor (not shown) or at least one external digital controller (not shown) to detect or control at least one environment status in which the power management apparatus 100 operates. The controller 122 may transmit the environment status to the remote apparatus 800 via the communication module 121 so as to allow the remote apparatus 800 to remotely monitor the power management apparatus 100 according to the environment status.

For example, the digital I/O port 125_1 may be connected to an access control system of the environment in which the power management apparatus 100 operates, and the digital I/O port 125_2 may be connected to an alarm in which the power management apparatus 100 operates. Accordingly, the controller 122 may identify whether any person illegally enters the environment in which the power management apparatus 100 operates via the digital I/O port 125_1 and trigger the alarm via the digital I/0 port 125_2. Alternatively, the controller 122 may transmit a message regarding that someone has illegally entered the environment in which the power management apparatus 100 operates to the remote apparatus 800. The remote apparatus 800 may trigger the alarm according to the message.

In an embodiment of the disclosure, the peripheral control circuit 120 may further include a display module 126. The display module 126 is connected to the controller 122 and may be configured to display an operation status of the power management apparatus 100. The display module 126 may be implemented by a seven-segment display or a light emitting diode (LED) module, and yet the disclosure is not limited thereto. For example, the display module 126 may be configured to display the following operation statuses of the power management apparatus 100: the power statuses of the AC powers PI1 and PI2, the power source of the supply power PS, the on/off statuses of the output switching circuits 164_3, 164_4, 166_3, and 166_4, the total energy consumption TPV of the external loads EL1-EL4, the current values IB1 and IB2 of the sub-power PS1 and PS2, the environment parameter EP, and so forth. The disclosure is not limited herein. More details would be provided later on. Moreover, the controller 122 may also be configured to detect an Internet protocol address (IP address) of the power management apparatus 100. In response to a press operation of a key module 127, the controller 122 may display the IP address and the aforesaid operation status of the power management apparatus 100 sequentially on the display module 126.

In an embodiment of the disclosure, the peripheral control circuit 120 may further include a sound module 128. The sound module 128 may emit a warning sound to prompt the user when the power management apparatus 100 is abnormal (e.g., the current IB1 of the sub-circuit 164 is overloaded to cause the circuit breaker 164_1 to trip off). Alternatively, in response to a press operation of the key module 127, the sound module 128 may emit a prompt sound to prompt the user. In an embodiment of the disclosure, the sound module 128 may be implemented by a buzzer.

In an embodiment of the disclosure, the power management apparatus 100 may further include AC-DC converting circuits 192 and 194 as illustrated in FIG. 1B. The AC-DC converting circuits 192 and 194 may be respectively connected to external power systems 920 and 940 to receive the AC powers PI1 and PI2, wherein the output terminals of the AC converting circuits 192 and 194 are connected to each other. The AC-DC converting circuits 920 and 940 may perform AC to DC conversion on the AC powers PI1 and PI2 to generate DC power Vdd required to operate the power management apparatus 100. In other words, the DC power Vdd is served as operation power for internal circuits or devices (e.g., the peripheral control circuit 120, the input switching circuit 140, and the output control circuit 160), and yet the disclosure is not limited herein. In an embodiment of the disclosure, the DC power Vdd required to operate the power management apparatus 100 may be provided by an external power apparatus.

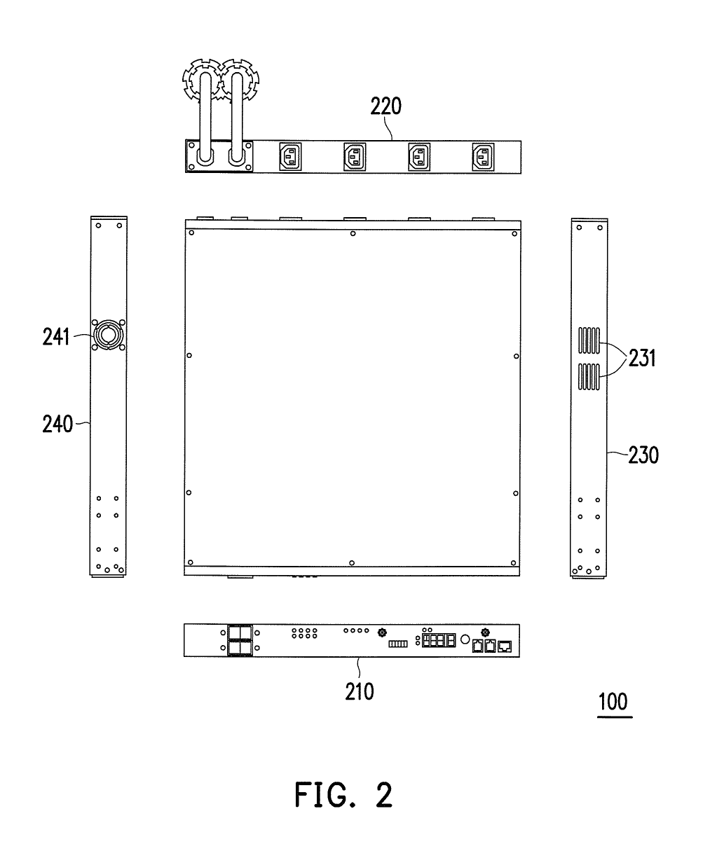

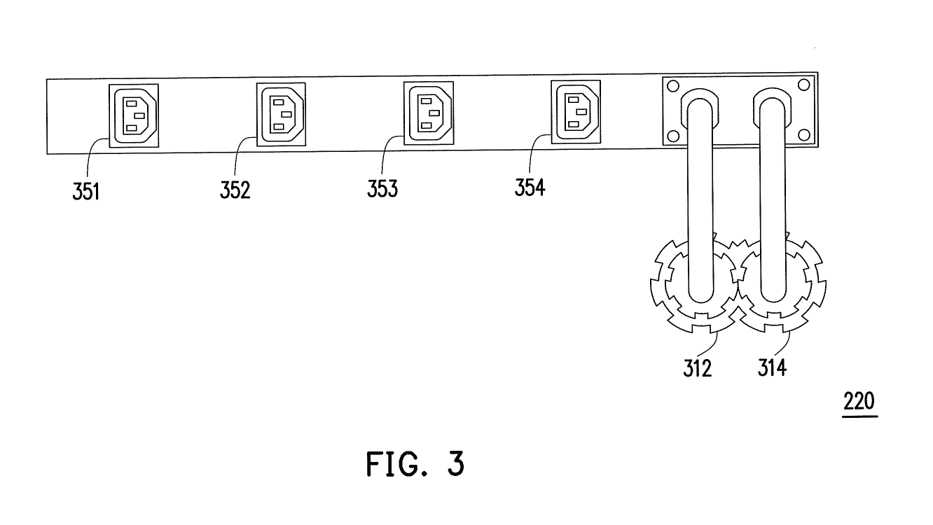

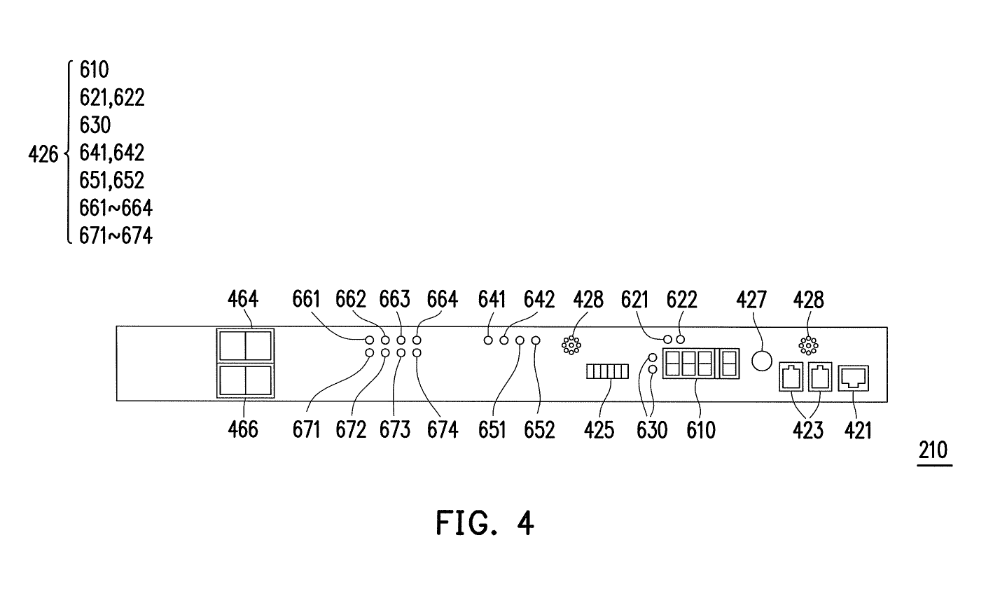

Refer to FIG. 1A, FIG. 1B, FIG. 1C, and FIGS. 2-4. FIG. 2 illustrates a decomposition diagram of the power management apparatus 100 in FIG. 1B. FIG. 3 is a configuration diagram of a back cover 220 of the power management apparatus 100 illustrated in FIG. 2. FIG. 4 is a configuration diagram of a front cover 210 of the power management apparatus 100 illustrated in FIG. 2. The power management apparatus 100 may include the front cover 210, the back cover 220, two side covers 230 and 240, and a main body 250. The front cover 210 and the back cover 220 are disposed opposite each other, and the side cover 230 and 240 are disposed opposite each other, where the side covers 230 and 240 may respectively have multiple heat dissipation holes 231 and 241. The main body 250 may include at least one printed circuit board 252, and the peripheral control circuit 120, the input switching circuit 140, the output control circuit 160, and AC-DC converting circuits 192 and 194 illustrated in FIG. 1B may be disposed on the printed circuit board 252.

As illustrated in FIG. 3, power input ports 312 and 314 and power output ports 351-354 may be disposed on the back cover 220. The external power system 920 illustrated in FIG. 1B may provide the AC power PI1 to the AC-DC converting circuit 192 and input switching circuit 140 via the power input port 312 illustrated in FIG. 3. Similarly, the external power system 940 illustrated in FIG. 1B may provide the AC power PI2 to the AC-DC converting circuit 194 and input switching circuit 140 via the power input port 314 illustrated in FIG. 3. The external load EL1 illustrated in FIG. 1B may be plugged into the power output port 351 illustrated in FIG. 3 to receive the output power PO1 provided by the output switching circuit 164_3. The external loads EL2-EL4 illustrated in FIG. 1B may be deduced in the same fashion.

As illustrated in FIG. 4, a display interface 426, a key interface 427, a sound interface 428, an Ethernet port 421, a sensor port 423, a digital I/O port 425, and circuit breaker holders 464 and 466 may be disposed on the front cover 210, and yet the disclosure is not limited thereto.

The display interface 426 may include a seven-segment display interface 610 and LED display interfaces 621, 622, 630, 641, 642, 651, 652, 611-664, and 671-674, and yet the disclosure is not limited thereto. In other embodiments of the disclosure, the display interface 426 may be implemented by other types of display interface such as a LCD interface, an OLED interface, or other suitable display interface. In response to a press operation of the key interface 427, the IP address and the operation status (i.e., the total energy consumption TPV of the external loads EL1-EL4, the current values IB1 and Ib2 of the sub-powers PS1 and PS2, and the environment parameter EP) may be displayed on the seven-segment display interface 610 sequentially.

The LED display interface 621 illustrated in FIG. 4 may be configured to indicate (or alert) whether the circuit breaker 164_1 of the sub-circuit 164 trips due to the overloaded current IB1. When the LED display interface 621 is on, it represents that the circuit breaker 164_1 of the sub-circuit 164 illustrated in FIG. 1B has tripped. Similarly, the LED display interface 622 illustrated in FIG. 4 may be configured to indicate (or alert) whether the circuit breaker 166_1 of the sub-circuit 166 trips due to the overloaded current IB2. When the LED display interface 622 is on, it represents that the circuit breaker 166_1 of the sub-circuit 166 illustrated in FIG. 1B has tripped.

The LED display interface 630 illustrated in FIG. 4 may be configured to indicate a status of the communication module 121 illustrated in FIG. 1C. For example, when the LED display interface 630 is on, it represents that the communication 121 illustrated in FIG. 1C has been connected to a network system.

When a light indicator of the LED display interface 630 flickers, it represents that the power management apparatus 100 is performing data transmission with the network system.

The LED display interfaces 641 and 642 illustrated in FIG. 4 may be respectively configured to indicate whether the external power systems 920 and 940 illustrated in FIG. 1B have power. For example, when the light indicator of the LED display interface 641 is on, it represents that the external power system 920 has power; that is, the power of the AC power PI1 is normal. Similarly, when the light indicator of the LED display interface 642 is on, it represents that the external power system 940 has power; that is, the power of the AC power PI2 is normal.

The LED display interfaces 651 and 652 illustrated in FIG. 4 may be configured to indicate whether the sub-circuits 164 and 166 illustrated in FIG. 1B are providing power to the external loads EL1-EL4. For example, when the light indicator of the LED display interface 651 is on, it represents that the sub-circuit 164 is providing power to the external loads EL1 and EL2. Similarly, when the light indicator of the LED display interface 652 is on, it represents that the sub-circuit 166 is providing power to the external loads EL3 and EL4.

The LED display interfaces 661-664 illustrated in FIG. 4 may be configured to indicate the on/off statuses of the output switching circuits 164_3, 1644, 166_3, and 166_4 illustrated in FIG. 4. For example, when the light indicator of the LED display interface 661 is on, it represents that the output switching circuit 164_3 is turned on; that is, the output switching circuit 164_3 is providing the output power PO1 to the external load ELL The statuses of the light indicators of the rest of the LED display interfaces 662-664 may be deduced in the same fashion, and thus would not be repeated herein.

The LED display interfaces 671-674 illustrated in FIG. 4 may be configured to indicate whether the current value IL1-IL4 of the output power PO1-PO4 are overloaded. For example, when the light indicator of the LED display interface 671 is on, it represents that the current value IL1 of the output power PO1 has been overloaded; that is, the current value IL1 of the output power PO1 is greater than or equal to the threshold ITH11. The statuses of the light indicators of the rest of the LED display interfaces 672-674 may be deduced in the same fashion, and thus would not be repeated herein.

The sound interface 428 illustrated in FIG. 4 may emit a warning sound to alert the user when the power management apparatus 100 is abnormal (e.g., the circuit breaker 164_1 trips due to the overloaded current IB1 of the sub-circuit 164. Alternatively, in response to a press operation of the key interface 427, the sound interface 428 may emit a warning sound to alert the user, and yet the disclosure is not limited herein.

The communication module 121 illustrated in FIG. 1C (e.g., an Ethernet module) may be connected to a network system via the Ethernet port 421 illustrated in FIG. 4. The operation of the sensor port 423 and the digital I/O port 425 illustrated in FIG. 4 may refer to the related description of the sensor port 123 and the digital I/O port 125 illustrated in FIG. 1C and would not be repeated herein.

In an embodiment of the disclosure, when the circuit breaker holder 464 as illustrated in FIG. 4 is shifted to the left, the circuit breaker 164_1 illustrated in FIG. 1B would be turned on so as to transmit the sub-power PS1 to the current measuring circuit 164_2. Once the current value IB1 of the sub-power PS1 is overloaded, the circuit breaker 164_1 may trip automatically. When the user overcomes the excessive current value IB1 of the sub-power PS1 (e.g., by turning off one of the output switching circuits 164_3 and 164_4), the circuit breaker holder 464 may be shifted to the right and then to the left to turn on the circuit breaker 164_1. Similarly, the circuit breaker holder 466 illustrated in FIG. 4 may refer to the description of the circuit breaker holder 464, and would not be repeated herein.

In summary, the power management apparatus in the disclosure provides a standby power feature. When the power source of the power management apparatus is abnormal, it may automatically switch the standby power source to allow a continuity of the power output by the power management apparatus. Moreover, the power management apparatus may be controlled by the remote apparatus so as to select a power source of the power management apparatus and may transmit a power utilizing information of the load (e.g., an appliance) of the power management apparatus and information of the environment in which the power management apparatus operates (e.g., a temperature value, a humility value, or a pressure value) to the remote apparatus via a wired network or a wireless network. Accordingly, the remote apparatus may remotely monitor the power management apparatus so as to enhance the reliability and the safety during the usage of appliances.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power management apparatus with a remote monitoring and standby power mechanism comprising:
a peripheral control circuit, connected to a control bus, and configured to receive an input signal from a remote apparatus and accordingly provide a control signal or a plurality of switching signals to the control bus;
an input switching circuit, connected to a plurality of external power systems to receive a plurality of alternating-current (AC) powers, and connected to the control bus to receive the control signal, wherein the input switching circuit selects one of the AC powers to be a supply power according to the control signal and detects a power status of each of the AC powers, and wherein when the power status of the selected AC power indicates that the selected AC power fails, the input switching circuit selects another AC power from the AC powers to be the supply power within a predetermined time duration; and
an output control circuit, connected to the input switching circuit to receive the supply power, and connected to the control bus to receive the switching signals,
wherein the output control circuit is controlled by the switching signals to provide a plurality of output powers to a plurality of external loads,
wherein the output control circuit detects a voltage and a current of the supply power to measure power utilizing information of the external loads, and
wherein the peripheral control circuit transmits the power status of each of the AC powers and the power utilizing information of the external loads to the remote apparatus so as to allow the remote apparatus to remotely monitor the power management apparatus.

2. The power management apparatus according to claim 1, wherein the output control circuit comprises:
an electric energy measuring circuit, connected to the input switching circuit to receive the supply power, and accordingly measuring a total energy consumption of the external loads and providing at least one sub-power; and
at least one sub-circuit, connected to the electric energy measuring circuit to receive the at least one sub-power, and connected to the control bus to receive the switching signals, wherein the at least one sub-circuit detects a current value of the at least one sub-power and is controlled by the switching signals to provide the output powers.

3. The power management apparatus according to claim 2, wherein the electric energy measuring circuit is connected to the control bus and compares the total energy consumption with a contract capacity, and wherein when the total energy consumption is greater than or equal to the contract capacity, the electric energy measuring circuit outputs the switching signals to disable the at least one sub-circuit.

4. The power management apparatus according to claim 2, wherein the electric energy measuring circuit is connected to the control bus, wherein the peripheral control circuit transmits the total energy consumption to the remote apparatus, wherein the remote apparatus compares the total energy consumption with a contract capacity, and wherein when the total energy consumption is greater than or equal to the contract capacity, the remote apparatus outputs the switching signals via the peripheral control circuit to disable the at least one sub-circuit.

5. The power management apparatus according to claim 2, wherein the at least one sub-circuit comprises:
a circuit breaker, connected to the electric energy measuring circuit to receive and transmit the at least one sub-power, and performing over-current protection on the at least one sub-circuit;
a current measuring circuit, connected to the circuit breaker to receive and transmit the at least one sub-power, and configured to measure the current value of the at least one sub-power; and
a plurality of output switching circuits, connected to the current measuring circuit to receive the at least one sub-power, wherein each of the output switching circuits is controlled by the corresponding switching signal to provide the corresponding output power to the corresponding external load.

6. The power management apparatus according to claim 5, wherein the current measuring circuit compares the current value of the at least one sub-power with a threshold, wherein when the current value of the at least one sub-power is greater than or equal to the threshold, the current measuring circuit outputs the switching signals to turn off the output switching circuits.

7. The power management apparatus according to claim 5, wherein the peripheral control circuit transmits the current value of the at least one sub-power to the remote apparatus, wherein the remote apparatus compares the current value of the at least one sub-power with a threshold, and wherein when the current value of the at least one sub-power is greater than or equal to the threshold, the remote apparatus outputs the switching signals via the peripheral control circuit to turn off the output switching circuits.

8. The power management apparatus according to claim 1, wherein the peripheral control circuit comprises:
a communication module, configured to receive the input signal from the remote apparatus; and
a controller, connected to the communication module, wherein the controller receives the input signal via the communication module, provides the control signal or the switching signals accordingly, and transmits the power status of each of the AC powers and the power utilizing information of the external loads to the remote apparatus via the communication module so as to allow the remote apparatus to remotely monitor the power management apparatus.

9. The power management apparatus according to claim 8, wherein the peripheral control circuit further comprises:
at least one sensor port, connected to the controller and configured to be plugged into at least one external sensor to detect at least one environment parameter of an environment in which the power management apparatus operates,
wherein the controller transmits the at least one environment parameter to the remote apparatus via the communication module so as to allow the remote apparatus to remotely monitor the power management apparatus according to the at least one environment parameter.

10. The power management apparatus according to claim 9, wherein the peripheral control circuit further comprises:
a storage module, connected to the controller and configured to store the at least one environment parameter.

11. The power management apparatus according to claim 8, wherein the peripheral control circuit further comprises:
at least one digital input/output (I/O) port, connected to the controller and configured to be plugged into at least one external digital sensor or at least one external digital controller to detect or control at least one environment status of an environment in which the power management apparatus operates,
wherein the controller transmits the at least one environment status to the remote apparatus via the communication module so as to allow the remote apparatus to remotely monitor the power management apparatus according to the at least one environment status.

12. The power management apparatus according to claim 8, wherein the peripheral control circuit further comprises:
a display module, connected to the controller, and configured to display a plurality of operation statuses of the power management apparatus,
wherein the controller is further configured to detect an Internet protocol (IP) address of the power management apparatus, and
wherein in response to a press operation of a key module, the controller sequentially displays the IP address and the operation statuses of the power management apparatus on the display module.

13. The power management apparatus according to claim 1 further comprising:
a plurality of alternating current to direct current (AC-DC) converting circuits, respectively connected to the external power systems to receive the AC powers, wherein an output terminal of each of the AC-DC converting circuits is connected to each other, and wherein each of the AC-DC converting circuits performs AC-DC conversion on the corresponding AC power to generate a DC power required to operate the power management apparatus.
